(19) United States
(12) Patent Application Publication
(10) Pub. No.: US 2026/0189458 A1
(43) Pub. Date: Jul. 2, 2026

(54) Monitoring System For Checking A System Integrity At A Subsequent Stage

(71) Applicant: Siemens Aktiengesellschaft, München (DE)

(72) Inventors: Rainer Falk, Erding (DE); Christian Peter Feist, Grafrath (DE); Stefan Pyka, Markt Schwaben (DE); Franz Sperl, Oberviechtach (DE); Peter Hornung, Erlangen (DE); Martin Mantel, Schmalkalden OT Wernshausen (DE); Thomas Zeschg, München (DE)

(73) Assignee: Siemens Aktiengesellschaft, München (DE)

(21) Appl. No.: 19/130,376

(22) PCT Filed: Nov. 15, 2023
(86) PCT No.: PCT/EP2023/081839

§ 371 Date: May 15, 2025

(30) Foreign Application Priority Data
Nov. 16, 2022 (EP) 22207862.8

(51) Int. Cl. H04L 41/0823; G06F 21/60; H04L 41/28

(52) U.S. Cl. CPC H04L 41/0823; G06F 21/602; H04L 41/28

(57) ABSTRACT

Some embodiments of the teachings herein include a monitoring system for checking an integrity of a reconfigurable system with a plurality of components. An example monitoring system includes: a receiving unit to receive a plurality of data sets, wherein each data set of the plurality of data sets originates from one of the plurality of components and describes a configuration change made to a respective component using change information indicating a type of the configuration change made; a checking unit to check a permissibility of the configuration changes made on the basis of the change information by checking the permissibility of whether the type of the configuration change made is permissible and/or plausible; and an output unit to provide an output based on the permissibility check.

### CROSS-REFERENCE TO RELATED APPLICATIONS

This application is a U.S. National Stage Application of International Application No. PCT/EP2023/081839 filed Nov. 15, 2023, which designates the United States of America, and claims priority to EP Application No. 22207862.8 filed Nov. 16, 2022, the contents of which are hereby incorporated by reference in their entirety.

### TECHNICAL FIELD

The present disclosure relates to monitoring systems. Various embodiments of the teachings herein include methods and/or systems for checking an integrity of a reconfigurable system, superordinate systems, and associated methods.

### BACKGROUND

Flexible production, in particular within the scope of Industry 4.0, is intended to enable rapid adaptation of automation solutions, in particular automation functions, to changing boundary conditions. This is also intended to be enabled by increasing digitization using open computer platforms for implementing virtualized automation functions. The adaptation of existing automation functions and the introduction of new automation functions are intended to be carried out more quickly in future. Automation systems will therefore be regularly subject to changes. The consequence for protecting the integrity of the automation system and the components contained therein is that preventing changes in order to ensure integrity is not a useful procedure since it would then not be possible to change the automation functions either.

Intrusion detection systems, IDS, which detect attacks are known. These can analyze the configuration on hosts (HIDS, host-based intrusion detection system) or the network communication (NIDS, network-based intrusion detection system). An IDS may generally detect a change in the behavior (anomaly-based IDS) or a known attack pattern (signature-based IDS) as an attack. Solutions for file integrity monitoring (FIM) which detect changes to a file system are known.

In the case of distributed ledgers (blockchain), it is known to use a program code (smart contract) defines whether a transaction is permissible, that is to say whether certain changing of the state managed in the distributed ledger is permissible in abstract terms. Rainer Falk, Steffen Fries, “System Integrity Monitoring for Industrial Cyber Physical Systems”, International Journal on Advances in Security, vol. 11, no. 1 & 2, year 2018, http://www.iariajournals.org/security, discloses an integrity monitoring system for cyber-physical systems. In this case, it is also known practice to determine the integrity of the cyber-physical system (CPS) in the real physical world by means of so-called “trusted sensors”. These provide trusted physical measurement data which can be used for a cross-comparison with the process image available in an automation system of the CPS.

Rainer Falk, Steffen Fries, “Enhancing the Resilience of Cyber-Physical Systems by Protecting the Physical-World Interface”, International Journal on Advances in Security, vol. 13, no. 1 & 2, year 2020, http://www.iariajournals.org/security, discloses that, in the case of a dynamically reconfigurable cyber-physical system, its integrity monitoring system must also be adapted accordingly to the respectively current configuration (reference policy) (see section IV.C “Policy Adaptation for Dynamically Reconfigurable CPS”).

Restoration points are known in operating systems, for example Microsoft Windows. In the case of a Windows system that is not functioning correctly, a user or administrator can return to an earlier, functional configuration status.

### SUMMARY

Teachings of the present disclosure provide solutions for improved protection of the system integrity of dynamically reconfigurable systems, in particular automation systems and industrial systems. For example, some embodiments of the teachings herein include a monitoring system (1) for checking an integrity of a reconfigurable system (2), wherein the reconfigurable system (2) has a plurality of components (21), the monitoring system (1) having: a receiving unit designed to receive a plurality of data sets, wherein each data set (23) of the plurality of data sets originates from one of the components (21) of the plurality of components of the reconfigurable system (2), wherein each data set (23) of the plurality of data sets describes at least one configuration change made to in each case one component (21) of the plurality of components of the reconfigurable system (2) by means of change information, wherein the change information respectively indicates a type of the at least one configuration change made, a checking unit designed to check a permissibility of the configuration change made in each case on the basis of the change information by checking the permissibility of whether the type of the at least one configuration change made is permissible and/or plausible, and an output unit designed to provide an output on the basis of a result of the checking.

In some embodiments, the reconfigurable system (2) is in the form of: a cyber-physical system and/or an Internet-of-Things system and/or an industrial system and/or an automation system and/or a manufacturing system and/or a control system and/or a robot and/or a production machine and/or a driverless transport system.

In some embodiments, the receiving unit is additionally designed to retrieve the plurality of data sets.

In some embodiments, the plurality of data sets each have cryptographic protection.

In some embodiments, the change information indicates: a time and/or a temporal beginning and/or a temporal conclusion and/or an initiator and/or an initiation location of the at least one configuration change made.

In some embodiments, the type of the at least one configuration change made comprises: a security-related change and/or a changed network configuration and/or a change to industrial project planning and/or installation of an update.

In some embodiments, the checking unit is designed to check the change information relating to a first configuration change made to a first component (21) of the plurality of components in conjunction with the change information relating to a second configuration change made to a second component (21) of the plurality of components.

In some embodiments, the checking unit is designed to use a program code, in particular a smart contract, and/or an algorithm based on artificial intelligence and/or at least one security guideline to check the permissibility.

In some embodiments, the checking unit is designed to use an effect of the at least one configuration change made and/or a changed input behavior and/or output behavior of the plurality of components caused by the at least one configuration change made, in particular a functional change, a performance change and/or a change in the real-time behavior, and/or a purpose of the at least one configuration change made to check the permissibility.

In some embodiments, the checking unit is also designed to create an assessment of an integrity of the respective component (21) of the plurality of components and/or an assessment of an integrity of the reconfigurable system (2) on the basis of the change information.

In some embodiments, the output is in the form of: an integrity confirmation and/or a cryptographically protected integrity confirmation and/or an integrity assessment and/or a warning message and/or a warning signal and/or an alarm and/or a command to stop production.

As another example, some embodiments include a superordinate system having: a monitoring system (1) as described herein, and a reconfigurable system (2), wherein the reconfigurable system (2) has the plurality of components.

In some embodiments, the superordinate system further comprises: a database (3) designed to provide the plurality of data sets, and/or an attestator (4) designed to create an integrity attestation (41) on the basis of the output.

As another example, some embodiments include a method for checking an integrity of a reconfigurable system (2), wherein the reconfigurable system (2) has a plurality of components, having the steps of: receiving (S1) a plurality of data sets, wherein each data set (23) of the plurality of data sets originates from one of the components (21) of the plurality of components of the reconfigurable system (2), wherein each data set (23) of the plurality of data sets describes at least one configuration change made to in each case one component (21) of the plurality of components of the reconfigurable system by means of change information, wherein the change information respectively indicates a type of the at least one configuration change made, checking (S2) a permissibility of the configuration change made in each case on the basis of the change information, wherein the checking comprises checking whether the type of the at least one configuration change made is permissible and/or plausible, and outputting (S3) an output on the basis of a result of the checking.

### BRIEF DESCRIPTION OF THE DRAWINGS

The features and advantages of the teachings of the present disclosure are described in the following explanations of a plurality of exemplary embodiments with reference to the schematic drawings. In the drawings:

FIG. 1 shows a schematic illustration of a superordinate system having, inter alia, a monitoring system incorporating teachings of the present disclosure; and

FIG. 2 shows a flowchart of an example method incorporating teachings of the present disclosure.

### DETAILED DESCRIPTION

The teachings herein relate to monitorings system for checking an integrity of a reconfigurable system, wherein the reconfigurable system has a plurality of components. An example monitoring system includes:
a receiving unit designed to receive a plurality of data sets,
   wherein each data set of the plurality of data sets originates from one of the components of the plurality of components of the reconfigurable system,
   wherein each data set of the plurality of data sets describes at least one configuration change made to in each case one component of the plurality of components of the reconfigurable system by means of change information,
   wherein the change information respectively indicates a type of the at least one configuration change made,
a checking unit designed to check a permissibility of the configuration change made in each case on the basis of the change information by checking the permissibility of whether the type of the at least one configuration change made is permissible and/or plausible, and
an output unit designed to provide an output on the basis of a result of the checking.

The checking of the permissibility is not based on the comparison of the actual configuration with a fixed, predefined target configuration, but rather on checking whether the configuration changes made are permissible and/or plausible. The type of the at least one configuration change made describes a type of change made to a configuration of at least one component of the plurality of components of the reconfigurable system. The type of change indicates the manner in which the configuration was changed. Additionally, the type of change indicates, in particular, which functional category of the configuration was changed. A functional category of the configuration comprises, in particular, security functions, network functions, control functions, communication functions, management functions and/or identification functions.

A positive result of the checking of the permissibility of the configuration change made in each case means that a configuration change made to one of the components of the plurality of components of the reconfigurable system is permissible. Therefore, there is integrity of the respective component. If there is integrity for all components of the plurality of components, integrity of the entire reconfigurable system is inferred. The output unit is designed to provide the output on the basis of the integrity of the respective components and/or of the reconfigurable system.

A negative result of the checking of the permissibility of the configuration change made in each case means that a configuration change made to one of the components of the plurality of components of the reconfigurable system is impermissible. Therefore, there is no integrity of the respective component. If there is no integrity for at least one component of the plurality of components, a lack of integrity of the entire reconfigurable system is inferred. The output unit is designed to provide the output on the basis of the non-existent integrity of the respective components and/or of the reconfigurable system.

The reconfigurable system is in the form of a cyber-physical system (CPS), in particular.

In the sense of the disclosure, plurality should be understood as meaning a plural. Plurality should not be understood as meaning a greater proportion of a particular number. This applies both to the plurality of components and to the plurality of data sets.

The components of the plurality of components of the reconfigurable system are designed to provide the plurality of data sets. The plurality of data sets are each privacy-protected, in particular, for know-how protection, in particular by means of anonymization, pseudonymization, by using verifiable credentials/verifiable presentations, or by means of privacy-protecting cryptographic methods such as homomorphic encryption or secure multiparty computation.

Each data set of the plurality of data sets is formed and provided by the component in question itself, by an additional component associated with the component in question or by an app of the component in question. An additional component or app may repeatedly determine the configuration of a component, using OPC UA or using NETCONF, and can confirm the determined changes in a cryptographically protected manner with respect to configurations determined in the past. When monitoring configuration changes on a component itself, additional information may possibly be determined and confirmed, in particular what resulted in the configuration change, in particular which authentication credential and/or which communication protocol and/or which device interface was used in a configuration change (identifier or authentication credential/certificate in the case of remote access, in particular using HTTPS, NETCONF/TLS, NETCONF/ssh, OPC UA).

The integrity confirmation is privacy-protected for know-how protection, in particular by means of anonymization, pseudonymization, by using verifiable credentials/verifiable presentations, or by means of privacy-protecting cryptographic methods such as homomorphic encryption or secure multiparty computation.

With regard to a reconfigurable system, in particular a cyber-physical system, the plant operator, a plurality of machine manufacturers of the production machines used, a plurality of device manufacturers of the automation components used, an integrator, an IT department or an IoT cloud provider, in particular, have a legitimate interest in monitoring system integrity. However, they are each responsible only for one section (area of responsibility, AOR). Therefore, it is also proposed to filter the plurality of data sets according to different areas of responsibility and to make them available to a respective AOR monitoring system for checking. An AOR monitoring system in turn confirms whether the checked changes are permissible from the respective responsibility perspective.

A cyber-physical system (CPS) overall image is determined therefrom and indicates from the point of view of which AOR areas of responsibility there is integrity of the system. This information is made available, in particular, to a production planning system or a production data management system. The production planning for further production processes or the approval of produced products or downstream checks on the produced products may be performed depending on whether the CPS or the CPS areas used for this purpose, in particular production machines, are or were in a permissible state during production. The information can also be transferred to a CPS component management system, in particular a common device management system, in order to cause a rollback of configuration changes that are not identified as permissible.

Some embodiments include a monitoring system, in particular an integrity monitoring system, for industrial automation systems, which captures the plurality of data sets and therefore the change information relating to the plurality of components. The monitoring system checks the permissibility of the changes to the plurality of components of the reconfigurable system. Some monitoring systems reliably record configuration changes made and checks the type of configuration changes made at a subsequent stage by means of a program code, in particular by means of a smart contract. At a subsequent stage means that the configuration changes have already been made at the time of the check.

An integrity monitoring system for a reconfigurable system is therefore proposed, which integrity monitoring system permits configuration changes by monitoring and checking the plausibility of the type of observable changes, rather than by identifying changes as impermissible before they are made, like known integrity monitoring tools (File Integrity Monitoring (FIM), Intrusion Detection System (IDS)).

In abstract terms, this can be understood as meaning a type of distributed ledger (“blockchain”) in which, however, transactions (here: configuration changes to the reconfigurable system) are first recorded in a transaction database. It is only subsequently checked whether these transactions that are already present (because first recorded) in the database are permissible according to a smart contract.

For a cyber-physical system (CPS) that is under distributed control (distributed ledger, blockchain), this results in the advantage that restoration points make it possible to return to an earlier, still functional configuration status of the CPS in the event of problems or impermissible manipulations.

A conventional security approach is access control that closely controls access operations, with the result that only permissible actions can be performed. A further conventional approach involves identifying deviations from a reference state defined (configured or learnt) as an integer as a manipulation. Such conventional security approaches are based on a fixed configuration. The disadvantage is that they are therefore not suitable, if configuration changes are intended to be regularly carried out, for flexibly adapting a production system to different requirements. If restrictively configured, such security approaches would prevent a flexible configuration adaptation or reconfiguration of industrial automation and control systems (generally: Industrial IoT or cyber-physical systems). They are therefore useful only in static industrial systems. However, in systems which are intended to be dynamically reconfigurable, far-reaching changes must be permitted.

In contrast, a complementary security approach as described herein may be used reliably record the configuration changes made and to check the permissibility of the changes made at a subsequent stage.

In some embodiments, the reconfigurable system is in the form of:
a cyber-physical system and/or
an Internet-of-Things system and/or
an industrial system and/or
an automation system and/or
a manufacturing system and/or
a control system and/or
a robot and/or
a production machine and/or
a driverless transport system.

In some embodiments, the receiving unit is additionally designed to retrieve the plurality of data sets. The plurality of data sets can be retrieved, in particular, from a database by the receiving unit. The plurality of data sets and therefore the change information relating to the plurality of components are recorded in particular in a database (can also be referred to as a CPS component configuration change database), in particular in a relational database, in an object database or in a distributed transaction database (can also be referred to as a distributed ledger and/or blockchain). A history of the changes made to the plurality of components of the reconfigurable system is therefore available.

In some embodiments, the plurality of data sets each have cryptographic protection. This has the advantage that the plurality of data sets are protected against manipulation and valid change information is therefore assumed.

In some embodiments, the change information indicates:
a time and/or
a temporal beginning and/or
a temporal conclusion and/or
an initiator and/or
an initiation location
   of the at least one configuration change made. The initiator of the at least one configuration change made can also be referred to as an executor of the at least one configuration change made.

The monitoring system checks the permissibility of the configuration changes respectively made to the plurality of components of the reconfigurable system. For this purpose, in addition to the type of the at least one configuration change made, it is possible to evaluate when and/or by whom and/or at which location which change was made to a respective component of the reconfigurable system. This has the advantage that further information is included in order to check the permissibility, and the result of the checking is more durable. The permissibility of an individual configuration change can be checked. The permissibility of a series of a plurality of configuration changes can also be checked.

In some embodiments, the type of the at least one configuration change made comprises:
a security-related change and/or
a changed network configuration and/or
a change to industrial project planning and/or
installation of an update.

In some embodiments, the checking unit is designed to check the change information relating to a first configuration change made to a first component of the plurality of components in conjunction with the change information relating to a second configuration change made to a second component of the plurality of components.

The at least one configuration change made to a component can already be identified as impermissible on its own, but its effect on the reconfigurable system can additionally also be identified by virtue of inconsistencies between the components and a further configuration change made being able to be identified and assessed as impermissible, in particular. The checking unit is therefore designed, in particular, to check whether the components have been consistently reconfigured, in particular during a production set-up phase.

It is additionally checked, in particular, whether changes to the components, which have possible effects on the entire reconfigurable system, in particular a changed network configuration, are consistent in terms of content and are made in a consistent manner. This makes it possible to identify, in particular, whether identical or similar changes were applied to a plurality of components within a defined period.

The checking unit is also designed, in particular, to check whether configuration changes made serve a different purpose and/or are divided among different change processes. An impermissible configuration can be identified, in particular, by inconsistencies in these criteria.

In some embodiments, the checking unit is designed to use:
a program code, in particular a smart contract, and/or
an algorithm based on artificial intelligence and/or
at least one security guideline
   to check the permissibility. The permissibility of configuration changes made is therefore checked, in particular, by means of a smart contract, that is to say generally by means of a program code. The latter checks according to definable criteria, as a result of which there is a permissible configuration change to the CPS.

In some embodiments, the permissibility of configuration changes made is checked by means of an algorithm based on artificial intelligence, that is to say AI-based, in particular by training permissible configuration changes in a learning phase on the basis of criteria and identifying and possibly banning impermissible changes in the productive phase, that is to say identifying them as impermissible.

In some embodiments, the checking unit is designed to use:
an effect of the at least one configuration change made and/or
a changed input behavior and/or output behavior of the plurality of components caused by the at least one configuration change made, in particular a functional change, a performance change and/or a change in the real-time behavior, and/or
a purpose of the at least one configuration change made
   to check the permissibility. This may determine the input behavior and/or an output behavior of the plurality of components with respect to the plurality of data sets. This can be determined directly at input/output interfaces or on a data bus. A changed input behavior and/or an output behavior can itself be identified when unintentional, unintended indirect effects on some automation functions result. Both the input/output behavior of the CPS and of the components present therein and the configuration changes made to components of the CPS are therefore monitored. This information is used to determine, in particular, which configuration change resulted in an undesirable input/output behavior. In particular, an additional cross-comparison of the recorded configuration changes to the CPS components and of the input/output behavior of CPS automation/control functions identifies which changes might have resulted in an impermissible CPS behavior. A rollback to a correctly functioning version is then carried out, in particular automatically.

In some embodiments, the checking unit is also designed to create
an assessment of an integrity of the respective component of the plurality of components and/or
an assessment of an integrity of the reconfigurable system
   on the basis of the change information. The monitoring system classifies components of the plurality of components and/or the reconfigurable system not only as an integer or non-integer, but rather additionally indicates an assessment of the integrity, in particular in the form of a degree of trustworthiness. A higher assessment means a higher probability of integrity. A low assessment in comparison means a lower probability of integrity. The assessment additionally contains, in particular, information relating to which configuration change or which combination of changes, in particular as a reference to the change(s), resulted in the lower assessment of the integrity.

The assessment and/or the degree of trustworthiness can be determined for the reconfigurable system as a whole. A plurality of degrees of trustworthiness can also be determined for different sections of the reconfigurable system. The sections may be firmly predefined, but the sections each having a consistent degree of trustworthiness may be determined dynamically.

In some embodiments, the output is in the form of:
an integrity confirmation and/or
a cryptographically protected integrity confirmation and/or
an integrity assessment and/or
a warning message and/or
a warning signal and/or
an alarm and/or
a command to stop production.

If the change is identified as impermissible, a corresponding output is effected in one embodiment. In some embodiments, an alarm is triggered or a production stop is initiated.

If the changes were identified as permissible, a cryptographically protected integrity confirmation, in particular an integrity attestation, is optionally formed and confirms that the reconfigurable system is currently or was in a defined period in a permissible integral state. The integrity confirmation is formed and output by the output unit. In some embodiments, an integrity confirmation, which can also be referred to as an integrity attestation, is formed and output, in particular by a downstream integrity confirmation unit, in particular a CPS system integrity attestator. In the case of a downstream integrity confirmation unit, this receives the result of the checking of the permissibility, which is formed by the checking unit.

Some embodiments include a superordinate system having:
a monitoring system as claimed in one of the preceding claims, and
a reconfigurable system, wherein the reconfigurable system has the plurality of components.

The plurality of components are designed to provide the plurality of data sets. The components are in the form of automation components, in particular. For this purpose, a unit for determining configuration changes and, in particular, for confirming the identified configuration changes in a cryptographically protected manner is provided on the components.

In some embodiments, the superordinate system also has:
a database designed to provide the plurality of data sets, and/or
an attestator designed to create an integrity attestation on the basis of the output.

Some embodiments include a method for checking an integrity of a reconfigurable system, wherein the reconfigurable system has a plurality of components, having the steps of:
receiving a plurality of data sets,
   wherein each data set of the plurality of data sets originates from one of the components of the plurality of components of the reconfigurable system,
   wherein each data set of the plurality of data sets describes at least one configuration change made to in each case one component of the plurality of components of the reconfigurable system by means of change information,
   wherein the change information respectively indicates a type of the at least one configuration change made,
checking a permissibility of the configuration change made in each case on the basis of the change information, and
outputting an output on the basis of a result of the checking.

Some embodiments include a method for checking an integrity of a reconfigurable system using a monitoring system as described herein.

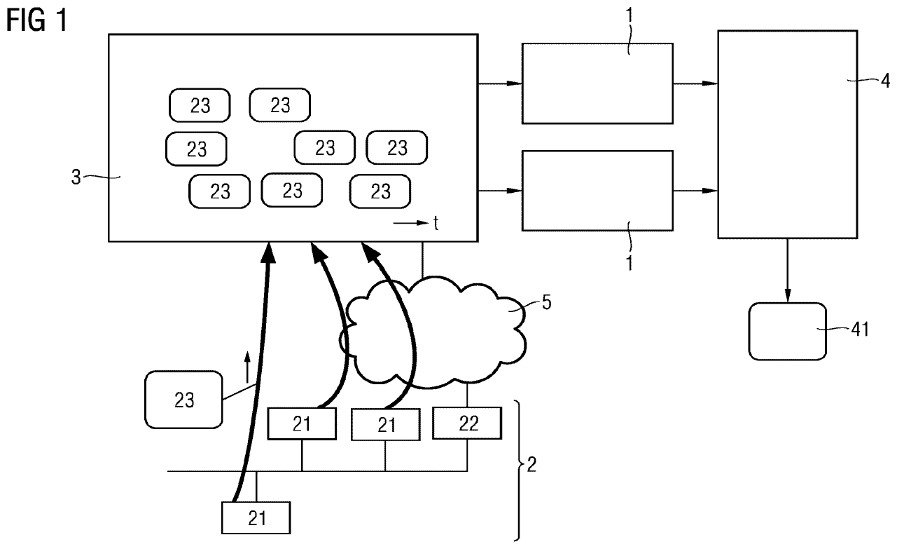

FIG. 1 shows a superordinate system having:
a monitoring system 1 according to the invention, divided into two monitoring systems 1 for different sections of a reconfigurable system 2,
the reconfigurable system 2, wherein the reconfigurable system 2 has the plurality of components 21 and the plurality of components 21 are connected to a database 3 via a gateway 22 and a network 5,
the database 3 designed to provide the plurality of data sets 23 to the monitoring systems 1 (stored over time t) and to receive the plurality of data sets 23 from the reconfigurable system 2, wherein each data set of the plurality of data sets 23 describes at least one configuration change made to in each case one component 21 of the plurality of components 21 of the reconfigurable system 2 by means of change information, wherein the change information respectively indicates a type of the at least one configuration change made, and
an attestator 4 designed to create an integrity attestation 41 on the basis of an output of the monitoring system 1.

FIG. 1 therefore shows, in particular, an implementation example with three CPS components 21 in an automation network 2. Two system integrity monitoring units 1 for two different areas of responsibility are also shown. An area of responsibility may be provided, for example, by a subset of the CPS components 21 and/or by the type, that is to say the functional category, of configuration changes made.

The proposed monitoring system 1, also an integrity monitoring system 1, can clearly be understood as a type of distributed ledger (blockchain), in which a smart contract checks the permissibility of a series of transactions, recorded in the data sets 23. However, the configuration changes have already been made and the corresponding transactions have already been stored in the database 3. Unlike in the case of a known blockchain/distributed ledger, however, their permissibility is only checked at a subsequent stage. A repeated check according to the different areas of responsibility can also be carried out, that is to say by means of a plurality of “smart contracts”. A result of the check is provided.

An integrity attestation 41 is optionally determined from the result of the check by an attestator 4 in order to indicate that the configuration changes that have already been made were permissible according to the transactions stored in the database 3 or whether this was not the case. The integrity attestation 41 can indicate, in particular, which functional areas, in particular for which production machines or which production lines (area of responsibility) of the reconfigurable system 2, the configuration changes used for the functional areas were permissible.

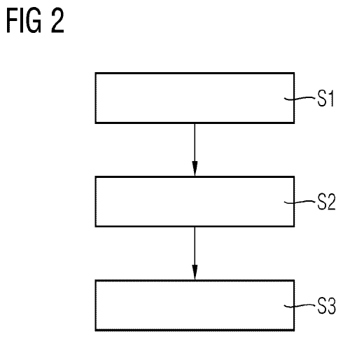

FIG. 2 shows an method for checking an integrity of a reconfigurable system 2, wherein the reconfigurable system 2 has a plurality of components, having the steps of:
step S1: receiving a plurality of data sets, wherein each data set 23 of the plurality of data sets originates from one of the components 21 of the plurality of components of the reconfigurable system 2,
   wherein each data set 23 of the plurality of data sets describes at least one configuration change made to in each case one component 21 of the plurality of components of the reconfigurable system by means of change information,
   wherein the change information respectively indicates a type of the at least one configuration change made,
step S2: checking a permissibility of the configuration change made in each case on the basis of the change information, wherein the checking comprises checking whether the type of the at least one configuration change made is permissible and/or plausible, and
step S3: outputting an output on the basis of a result of the checking.

Although the teachings herein have been described and illustrated more specifically in detail by means of the exemplary embodiments, the scope of the disclosure is not restricted by the disclosed examples and other variations can be derived therefrom by a person skilled in the art without departing from the scope of protection.

What is claimed is:

1. A monitoring system for checking an integrity of a reconfigurable system with a plurality of components, the monitoring system comprising:
a receiving unit to receive a plurality of data sets,
wherein each data set of the plurality of data sets originates from one of the plurality of components and
describes configuration change made to respective component using change information indicating a type of the configuration change made;
a checking unit to check a permissibility of the configuration changes made on the basis of the change information by checking the permissibility of whether the type of the configuration change made is permissible and/or plausible; and
an output unit to provide an output based on the permissibility check.

2. The monitoring system as claimed in claim 1, wherein the reconfigurable system comprises a system selected from the group consisting of:
a cyber-physical system,
an Internet-of-Things system,
an industrial system,
an automation system,
a manufacturing system,
a control system,
a robot,
a production machine, and
a driverless transport system.

3. The monitoring system as claimed in claim 1, wherein the receiving unit retrieves the plurality of data sets.

4. The monitoring system as claimed in claim 1, wherein each data set of the plurality of data sets has respective cryptographic protection.

5. The monitoring system as claimed in claim 1, wherein each change information indicates at least one of:
a time,
a temporal beginning,
a temporal conclusion,
an initiator, and/or
an initiation location of the configuration change made.

6. The monitoring system as claimed in claim 1, wherein the type of the configuration change made comprises at least one of:
a security-related change,
a changed network configuration,
a change to industrial project planning, and/or
installation of an update.

7. The monitoring system as claimed in claim 1, wherein the checking unit checks the change information relating to a first configuration change made to a first component in conjunction with the change information relating to a second configuration change made to a second component.

8. The monitoring system as claimed in claim 1, wherein the checking unit uses
a program code,
an algorithm based on artificial intelligence, and/or a
security guideline to check the permissibility.

9. The monitoring system as claimed claim 1, wherein the checking unit is uses:
an effect of the configuration change made,
a changed input behavior and/or output behavior of the plurality of components caused by the configuration change made, and/or
a purpose of the at least one configuration change made,
to check the permissibility.

10. The monitoring system as claimed in claim 1, wherein the checking unit creates:
an assessment of an integrity of the respective component of the plurality of components and/or
an assessment of an integrity of the reconfigurable system on the basis of the change information.

11. The monitoring system as claimed in claim 1, wherein the output includes:
an integrity confirmation,
a cryptographically protected integrity confirmation,
an integrity assessment,
a warning message,
a warning signal,
an alarm and/or
a command to stop production.

12. A superordinate system having:
a reconfigurable system comprising a plurality of components;
a receiving unit to receive a plurality of data sets, wherein each data set of the plurality of data sets originates from one of the plurality of components and describes a configuration change made to a respective component using change information indicating a type of the configuration change made;
a checking unit check a permissibility of the configuration changes made on the basis of the change information by checking the permissibility of whether the type of the configuration change made is permissible and/or plausible; and
an output unit to provide an output based on the permissibility check.

13. The superordinate system as claimed in claim 12, further comprising
a database to provide the plurality of data sets, and/or
an attestator to create an integrity attestation on the basis of the output.

14. A method for checking an integrity of a reconfigurable system having a plurality of components, the method comprising:
receiving a plurality of data sets, wherein each data set originates from a respective one of the plurality of components and
describes a configuration change made to the respective component using change information indicating
a type of the configuration change made;
checking a permissibility of the configuration change made in each case on the basis of the change information, wherein the checking comprises checking whether the type of the at least one configuration change made is permissible and/or plausible, and
generating an output on the basis of a result of the checking.

15. (canceled)
